(19) United States
(12) Patent Application Publication
(10) Pub. No.: US 2017/0013833 A1
(43) Pub. Date: Jan. 19, 2017

(54) PROACTIVE REPELLENT AND CAMP PERIMETER DEFENSE AGAINST APEX PREDATORS

(71) Applicant: CAMP GARD LLC, Liberty Lake, WA (US)

(72) Inventor: EDGAR PAUL SHIELDS, LIBERTY LAKE, WA (US)

(73) Assignee: CAMP GARD LLC, LIBERTY LAKE, WA (US)

(21) Appl. No.: 14/800,496

(22) Filed: Jul. 15, 2015

(51) Int. Cl. A01N 35/02; A01M 29/12

(52) U.S. Cl. CPC A01N 35/02; A01M 29/12

(57) ABSTRACT

A proactive repellent and camp perimeter defense against apex predators is provided. In an implementation, the proactive repellent is a liquid agent or aerosol tuned to the sensitive olfactory senses of apex predators. Ingredients catch the attention of the apex predator, while also providing olfactory aversion signals. The example repellent can be applied around an area to be proactively protected via delivery methods such as spray, aerosol, gel, or stream apparatuses, or by foam, cloth, gauze, sponge, wick, or swab applicators. The repellent then dries, emitting repellent odors and chemicals in both liquid and dried states. The example repellent may be pre-applied to artifacts, such as string, cord, or ribbon for surrounding a campsite, or on cards, tubes, sticks, balls, granules, and stakes. An example device may be worn by a hiker as a cartridge, nodule, capsule, aerator, or fabric evaporator, and then reused by rewetting with the example repellent.

### BACKGROUND

Apex predator attacks are on the rise. “Apex predator,” as used herein, means those bears, cougars, and wolves posing a danger to North American hikers and campers, but may also include tigers, lions, hyenas, civets, and other large and small predators on other continents. While apex predators are usually considered for their ability to hurt or potentially kill a human adult, an apex predator may also attack children, infants, pets, cooked meals, food supplies, and throwaways within the perimeter of a camp.

Apex predators of the bear family (Ursidae) may include eight species, the American black bear, the brown/grizzly bear, the polar bear, the giant Panda bear, the Asiatic bear, the spectacled bear, the sloth bear, and the sun bear. However, brown bears (such as grizzly bears, Kodiak bears) are particularly feared, and along with polar bears are the largest land-based predators on earth.

Apex predators of the cat family (Felidae) belong to one of two subfamilies: tiger, lion, jaguar, leopard, and snow leopard (Pantherinae), and cougar, cheetah, lynx, ocelot, leopard cat, and domestic cat (Felinae). The cougar (Puma concolor), also called the mountain lion, puma, or catamount, is the second-heaviest cat in the Americas after the jaguar, and is nocturnal and secretive. The cougar is an ambush predator and pursues a wide variety of prey. Fatal attacks on humans are rare, but attacks on children in North America have been increasing as more humans enter their territory.

Apex predators of the dog family (Canidae) include wolves, coyotes, jackals, wild dogs, and foxes, for example. Since the Canids are social animals, they hunt in packs, and their danger is multiplied by their numbers, even against other apex predators.

Currently there are only reactive remedies against an immediately occurring attack, such as pepper spray, firearms, and so forth. Firearms are expensive, unwieldy, and ineffective in the hands of the untrained, as well as being dangerous around children and illegal in many parks and in Canada. Defensive sprays are also expensive, reactive, and can potentially disable the user as well as anger the predator. It is often difficult to effectively deploy a pepper spray, for example, without at least a little of the product returning to irritate the user.

### BRIEF DESCRIPTION OF DRAWINGS

FIG. 1 is a diagram of an example camp perimeter defense using a proactive repellent for apex predators.

FIG. 2 is a diagram of an example portable proactive deterrent for apex predators.

FIG. 3 is a flow diagram of an example method of making and using a proactive repellent for apex predators.

### DETAILED DESCRIPTION

Overview

This disclosure describes a proactive repellent and camp perimeter defense against apex predators. In an implementation, the proactive repellent is a liquid agent tuned to the particularly sensitive olfactory senses of apex predators. The example repellent is aversive to apex predators, which find the repellent distressing, threatening, repugnant, or sickening. In an implementation, the example repellent contains ingredients to catch the attention of the apex predator, while also providing olfactory aversion signals to the predator. In an implementation, the example repellent also has very low toxicity. The example repellent may also be made from environmentally safe compounds.

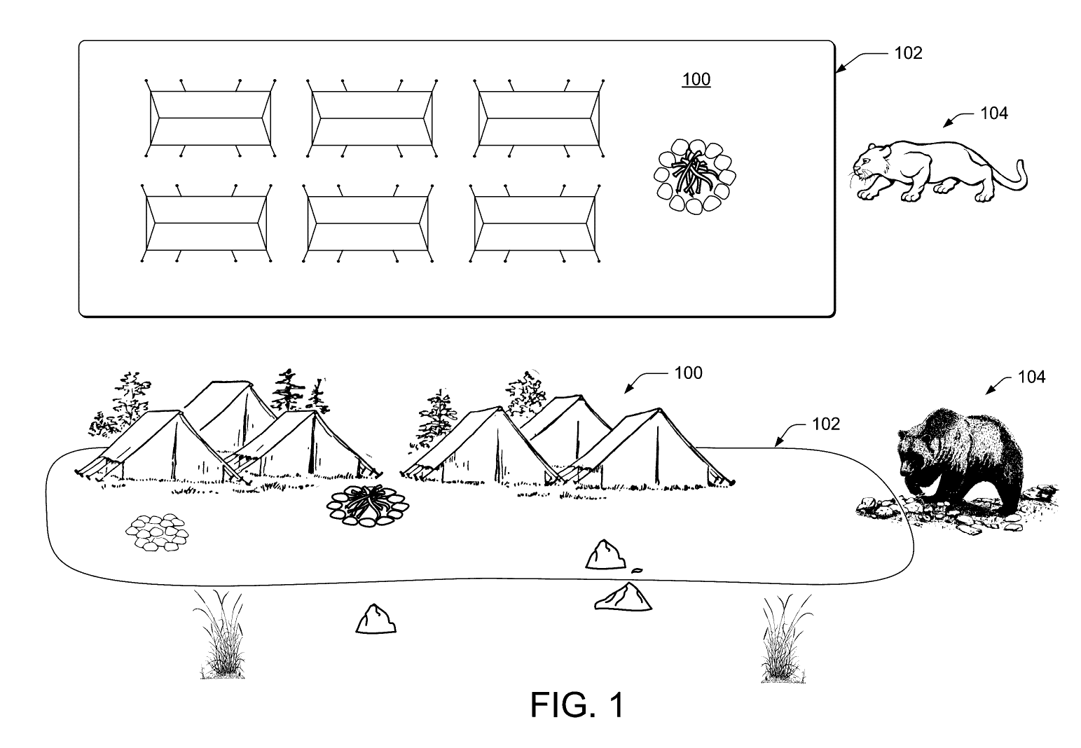

FIG. 1 shows an example area 100, a campsite to be proactively protected by the example repellent 102 from an apex predator 104. In an implementation, the example repellent 102 can be applied around the area 100 to be proactively protected via delivery methods such as by spray, aerosol, gel, stream, or squirt apparatuses, or by foam, cloth, gauze, sponge, wick, or swab applicators. The repellent 102 then dries, emitting odors and chemicals in both liquid and dried states.

In an implementation, the example repellent 102 is pre-applied to artifacts or devices convenient for particular circumstances. For example, a repellent cord 102, string, or ribbon may be pre-soaked or pre-exposed to the example repellent 102, for surrounding the area 100, such as the campsite. The repellent cord 102, string, or ribbon creates a deterrent and repellent boundary that is likely to drive away the apex predator 104.

Artifacts containing or covered with the example proactive repellent 102 may also be cards, tubes, sticks, balls, beads, gels, granules, stakes, and so forth, soaked, sprayed, exposed to, or impregnated with the example repellent 102, and spaced apart from each other to create a protective boundary around the campsite or other area 100. The example repellent 102 does not have to stay liquid, but may dry on the artifact, emitting repellent odors and chemicals. In an implementation, the artifacts may come pre-packaged, and previously exposed to the example repellent 102. Opening a wrapper activates the artifact or device by allowing the odors or chemicals to spread and diffuse.

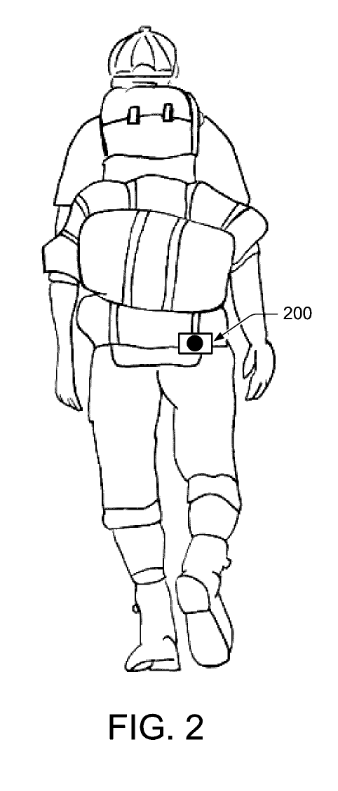

FIG. 2 shows a portable deterrent 200 to carry on a user's person or backpack. The portable deterrent 200 may consist of a self-saturating foam, cloth, gauze, sponge, wick, fiber pad, or swab that wicks the example repellent 102 to the open air from a supply. The portable deterrent 200 may also be reusable, such as periodically wetted with the example repellent 102 from a separate supply.

An example portable proactive deterrent 200 may also take the form of a cartridge, nodule, capsule, aerator, cotton or fabric evaporator, etc., that can be reusable by rewetting with the example repellent 102 via an atomizer, spray bottle, or the like.

As a proactive deterrent or a camp perimeter defense, the example repellent 102 and its application techniques differ from conventional reactive defense sprays, such as bear sprays and pepper sprays, in that the example liquid is not sprayed or streamed directly at an attacking or stalking animal 104, but rather is preferably applied to inanimate objects that the apex predator 104 encounters while approaching a person or a campsite. Thus, the example repellent 102 may be applied while no animal is present, and may proactively deter and repel apex predators for days.

Example Repellent

The example repellent 102 does not have to remain liquid in order to deter and repel apex predators 104, for up to days at a time. The example repellent 102 is formulated to target the sensitive and discriminating olfactory and/or taste senses of apex predators 104.

In an implementation, the example repellent 102 includes methyl nonyl ketone (2-undecanone), methyl octyl ketone (2-decanone), and cinnamic aldehyde (cinnamaldehyde or (2E)-3-phenylprop-2-enal) in various proportions. This combination of ingredients targets or catches the focused attention of apex predators 104 while imposing aversive olfactory signals onto the predator 104.

The scent or odor of the example repellent 102 is unnoticeable or barely noticeable to humans, and may have pleasant smell overtones to humans. The scent of the example repellent 102, however, is aversive to apex predators 104 who then endeavor to avoid it. The scent may be displeasing to the apex predators 104 as an odor, but the scent may also trip additional territory-marking and hormonal mechanisms possessed by apex predators 104, repelling the apex predators 104 away from the vicinity of the example repellent 102.

In an implementation, the example repellent 102 includes a vehicle, such as an alcohol-water mixture. The vehicle dissolves or emulsifies the organic active ingredients, which are polar and insoluble in water, but soluble or miscible in alcohol. Upon application, the vehicle evaporates, leaving the organic active ingredients on a surface. In an implementation, the example repellent 102 also contains an additional emulsifier or a binder. An emulsifier or binder may prolong the effectiveness of the example repellent 102 in repelling apex predators 104 past 48 hours: up to one week, for example.

In an implementation, the example repellent 102 contains (by volume percentage at standard temperature and pressure) isopropyl alcohol in a range from approximately 57.0-58.5%, purified water in a range from approximately 38.0-39.0%, methyl nonyl ketone in a range from approximately 1.0-2.0%, methyl octyl ketone in a range from approximately 1.0-2.0%, and cinnamic aldehyde in a range from approximately 0.5-1.0%.

In an implementation, the example repellent 102 contains (by volume percentage at STP) approximately 58.5% isopropyl alcohol, approximately 39.0% purified water, approximately 1.0% methyl nonyl ketone, approximately 1.0% methyl octyl ketone, and approximately 0.5% cinnamic aldehyde.

In an implementation, the example repellent 102 contains (by volume percentage) approximately 57.75% isopropyl alcohol, approximately 38.5% purified water, approximately 1.5% methyl nonyl ketone, approximately 1.5% methyl octyl ketone, and approximately 0.75% cinnamic aldehyde.

In an implementation, the example repellent 102 contains (by volume percentage) approximately 57.0% isopropyl alcohol, approximately 38.0% purified water, approximately 2.0% methyl nonyl ketone, approximately 2.0% methyl octyl ketone, and approximately 1.0% cinnamic aldehyde.

The example repellent 102 may also include an emulsifier to maintain the repellent as an emulsion. Similarly, the example repellent may include a binder to adhere the repellent to a surface. The example repellent may also contain a gelling agent to cast the composition as a gelatin, jelly, hydrogel, covalent polymer network, or fibril network.

In an implementation, the example repellent 102 formulated above also contains an oleoresin or a balsam. The oleoresin may be an oleoresin capsicum, as is used in pepper sprays. However, in an implementation, the oleoresin capsicum is stabilized and/or emulsified.

Example Application and Delivery

A proactive and preemptive deterrent 102 greatly decreases the chance of an attack by an apex predator 104 before desperate reactive measures are needed. In an implementation, the example proactive repellent 102 is utilized in a low attack-threat area or a high attack-threat area before an encounter with an apex predator 104 (e.g., bear, cougar, wolf) takes place. The proactive repellent 102 is easy to deploy by an untrained user, and may also be inexpensive.

By applying the example proactive repellent 102, for example along a sprayed perimeter around the area 100 to be protected, the bear, cougar, or wolves are less likely to enter the area 100 where an attack could happen. The example proactive repellent 102 contains scents unpleasant to predators. The proactive repellent 102 may also be applied to clothing or shoes while hiking in predator areas, or used in the example portable deterrent 200.

In an implementation, the example proactive repellent 102 is sprayed approximately 50 to 100 feet from an area 100 to be protected to form a perimeter around the area 100 or around the items to be protected from apex predators 104. In an implementation, the example proactive repellent 102 may be reapplied every 24 hours.

The example proactive repellent 102 does not have to form an unbroken perimeter, but in an implementation, there should be no more than five foot gaps between sprayed areas forming a perimeter around the area 100.

In an implementation, an apparatus employs a device for distributing a string, cord, or ribbon around at least part of a perimeter of an area to be protected from an apex predator 104, such as a cabin, yard, playground, garbage dump, or campsite. The string, cord, or ribbon includes the example repellent 102, formulated to repel apex predators 104. The device may be a spool or reel, or the like. The string, cord, or ribbon may be brightly colored for visibility to a user, or may be camouflaged to blend in with the surroundings. In an implementation, the distribution device may be an aerosol can or spray device that creates the string, cord, or ribbon out of ingredients in the can, including the repellent 102 when the aerosol can or spray device is actuated by the user. The string, cord, or ribbon may be brightly colored for visibility to the user.

Example Methods

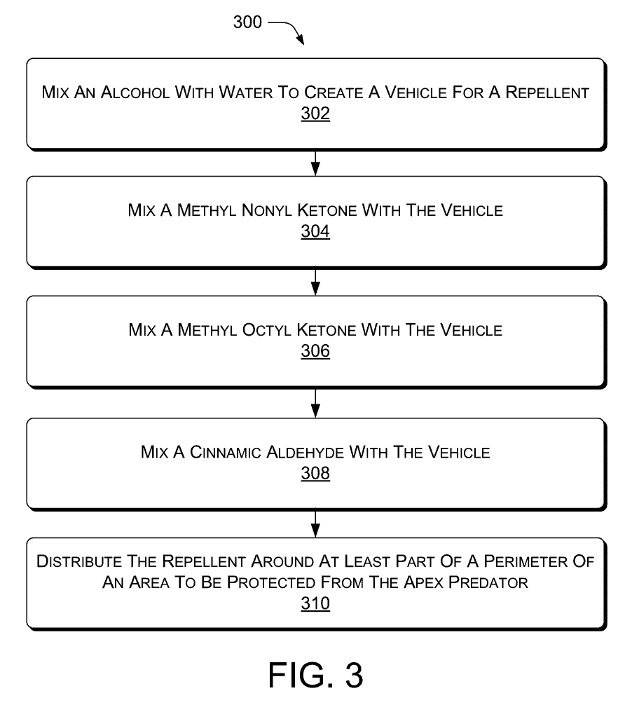

FIG. 3 shows an example method 300 of making and using a proactive repellent for apex predators. In the flow diagram, operations are shown in individual blocks.

At block 302, an alcohol is mixed with water to create a vehicle for a repellent.

At block 304, a methyl nonyl ketone is mixed with the vehicle.

At block 306, a methyl octyl ketone is mixed with the vehicle.

At block 308, a cinnamic aldehyde is mixed with the vehicle.

At block 310, the proactive repellent is distributed around at least part of a perimeter of an area to be protected from the apex predator.

Conclusion

Numerous variations and modifications will be readily apparent to those skilled in the art. Although example implementations have been described, it is to be understood that the compositions, methods, and apparatuses defined in the appended claims are not necessarily limited to the specific features or acts described above. Rather, the specific features and acts are disclosed as example forms of implementing the claims.

1. A perimeter defense, comprising:
at least a methyl nonyl ketone (2-undecanone), a methyl octyl ketone (2-decanone), and a cinnamic aldehyde ((2E)-3-phenylprop-2-enal) applicable to a perimeter around an area to be protected.

2. A proactive repellent against an apex predator comprising at least a methyl nonyl ketone (2-undecanone), a methyl octyl ketone (2-decanone), and a cinnamic aldehyde ((2E)-3-phenylprop-2-enal).

3. A composition, comprising:
methyl nonyl ketone (2-undecanone);
methyl octyl ketone (2-decanone); and
cinnamic aldehyde ((2E)-3-phenylprop-2-enal).

4. The composition of claim 3, further comprising an alcohol-water emulsifier.

5-6. (canceled)

7. The composition of claim 3, further comprising an isopropyl alcohol and water.

8. The composition of claim 7, further comprising, by volume percentage:
approximately 39.0% water;
approximately 58.5% isopropyl alcohol;
approximately 1.0% methyl nonyl ketone;
approximately 1.0% methyl octyl ketone; and
approximately 0.5% cinnamic aldehyde.

9. The composition of claim 7, further comprising, by volume percentage:
approximately 38.5% water;
approximately 57.75% isopropyl alcohol;
approximately 1.5% methyl nonyl ketone;
approximately 1.5% methyl octyl ketone; and
approximately 0.75% cinnamic aldehyde.

10. The composition of claim 7, further comprising, by volume percentage:
approximately 38.0% water;
approximately 57.0% isopropyl alcohol;
approximately 2.0% methyl nonyl ketone;
approximately 2.0% methyl octyl ketone; and
approximately 1.0% cinnamic aldehyde.

11. The composition of claim 7, further comprising an oleoresin or a balsam.

12. The composition of claim 11, wherein the oleoresin comprises an oleoresin capsicum.

13. The composition of claim 12, wherein the oleoresin capsicum is stabilized or emulsified.

14. An apparatus, comprising:
a scent emitter;
wherein the scent emitter contains at least a methyl nonyl ketone (2-undecanone), a methyl octyl ketone (2-decanone), and a cinnamic aldehyde ((2E)-3-phenylprop-2-enal; and
wherein the scent emitter is selected from the group consisting of a string, a cord, and a ribbon.

15. (canceled)

16. The apparatus of claim 14, wherein the scent emitter is preloaded with the at least a methyl nonyl ketone (2-undecanone), a methyl octyl ketone (2-decanone), and a cinnamic aldehyde ((2E)-3-phenylprop-2-enal.

17. The apparatus of claim 14, wherein the scent emitter is reusable by adding the at least a methyl nonyl ketone (2-undecanone), a methyl octyl ketone (2-decanone), and a cinnamic aldehyde ((2E)-3-phenylprop-2-enal from a supply of the repellent.

18. An apparatus, comprising:
a scent emitter;
wherein the scent emitter repellent contains at least a methyl nonyl ketone (2-undecanone), a methyl octyl ketone (2-decanone), and a cinnamic aldehyde ((2E)-3-phenylprop-2-enal); and
wherein the scent emitter is selected from the group consisting of a card, a tube, a stick, a ball, a bead, a gel, a granule, and a stake.

19. (canceled)

20. The apparatus of claim 18, wherein the scent emitter is preloaded with the methyl nonyl ketone (2-undecanone), the methyl octyl ketone (2-decanone), and the cinnamic aldehyde ((2E)-3-phenylprop-2-enal).

21. The apparatus of claim 18, wherein the scent emitter is reusable by adding the methyl nonyl ketone (2-undecanone), the methyl octyl ketone (2-decanone), and the cinnamic aldehyde ((2E)-3-phenylprop-2-enal) repellent from a supply of the repellent.

22. A method for preparing a repellant, comprising:
mixing water with an isopropyl alcohol to create a vehicle;
mixing a methyl nonyl ketone with the vehicle;
mixing a methyl octyl ketone with the vehicle; and
mixing a cinnamic aldehyde with the vehicle.

23. The method of claim 22, wherein the repellent comprises:
the water in a range of approximately 38.0-39.0% by volume;
the an isopropyl alcohol in a range of approximately 57.0-58.5% by volume;
the methyl nonyl ketone in a range of approximately 1.0-2.0% by volume;
the methyl octyl ketone in a range of approximately 1.0-2.0% by volume; and
the cinnamic aldehyde in a range of approximately 0.5-1.0% by volume.

24. The method of claim 23, further comprising distributing the repellent around at least part of a perimeter of an area to be protected from an apex predator.

25. The method of claim 24, further comprising placing a string, cord, or a ribbon that includes the repellent around at least part of the perimeter of the area to be protected.

26. The method of claim 24, further comprising placing an artifact that includes the repellent around at least part of the perimeter of the area to be protected, wherein the artifact is selected from the group consisting of a card, a tube, a stick, a ball, a bead, a gel, a granule, and a stake.

27. An apparatus, comprising:
a string, cord, or ribbon;
a device for distributing the string, cord, or ribbon around at least part of a perimeter of an area to be protected from an apex predator; and
wherein the string, cord, or ribbon includes a repellent formulated to repel apex predators; and
wherein the repellant comprises at least a methyl nonyl ketone (2-undecanone), a methyl octyl ketone (2-decanone), and a cinnamic aldehyde ((2E)-3-phenylprop-2-enal).

28. (canceled)

29. The apparatus of claim 27, wherein the device comprises a spool or reel.

30. The apparatus of claim 27, wherein the string, cord, or ribbon is brightly colored for visibility to a user.

31. The apparatus of claim 27, wherein the device comprises an aerosol can that creates the string, cord, or ribbon comprising the repellent when the aerosol can is sprayed by a user.

32. The apparatus of claim 31, wherein the string, cord, or ribbon is brightly colored for visibility to a user.
